(19) United States
(12) Patent Application Publication
(10) Pub. No.: US 2008/0162560 A1
(43) Pub. Date: Jul. 3, 2008

(54) INVOKING CONTENT LIBRARY MANAGEMENT FUNCTIONS FOR MESSAGES RECORDED ON HANDHELD DEVICES

(76) Inventors: William K. Bodin, Austin, TX (US); David Jaramillo, Lake Worth, FL (US); Jesse W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/619,229

(22) Filed: Jan. 3, 2007

(51) Int. Cl. G06F 17/00

(52) U.S. Cl. 707/104.1

(57) ABSTRACT

Methods, systems, and computer program products are provided for invoking content library management functions. Embodiments include receiving, by a library management system, a media file containing a message recorded on a handheld recording device; converting, by the library management system, the recorded message to text; identifying, by the library management system, a library management function in dependence upon the text; identifying in dependence upon the text, by the library management system, content under management upon which to invoke the library management function; and invoking, by the library management system, the identified library management function on the identified content. Embodiments also typically include recording the message on handheld recording device, and communicating the media file containing the message to the library management system. Embodiments also typically include invoking an e-mail management function on a server, and invoking a correlated e-mail management function on a corresponding client coupled to the server.

### BACKGROUND OF THE INVENTION

1. Field of the Invention

The field of the invention is data processing, or, more specifically, methods, systems, and products for invoking content library management functions for messages recorded on handheld devices.

2. Description of Related Art

Managers are increasingly isolated from one another, and their employees. One reason for this isolation is that managers are often time constrained, and their communication occurs with many different devices, and often communications requires two or more managers or employees to be available at the same time. There therefore is a need for improvement in communications among users such as managers and employees that facilitates performing desired functions, and reduces the requirement for more than one user to communicate at the same time.

### SUMMARY OF THE INVENTION

Methods, systems, and computer program products are provided for invoking content library management functions. Embodiments include receiving, by a library management system, a media file containing a message recorded on a handheld recording device; converting, by the library management system, the recorded message to text; identifying, by the library management system, a library management function in dependence upon the text; identifying in dependence upon the text, by the library management system, content under management upon which to invoke the library management function; and invoking, by the library management system, the identified library management function on the identified content. Embodiments also typically include recording the message on handheld recording device, and communicating the media file containing the message to the library management system. Embodiments also typically include invoking an e-mail management function on a server, and invoking a correlated e-mail management function on a corresponding client coupled to the server.

The foregoing and other objects, features and advantages of the disclosure will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for invoking content library management functions for messages recorded on handheld recording devices according to embodiments of the present invention.

FIG. 2 sets forth a block diagram of automated computing machinery comprising an exemplary library management system useful in invoking content library management functions according to embodiments of the present invention.

FIG. 3 sets forth a flow chart illustrating an exemplary method for invoking content library management functions according to embodiments of the present invention.

FIG. 4 sets forth a flow chart illustrating an exemplary method for identifying a library management function in dependence upon a text converted from a recorded message.

FIG. 5 sets forth a flow chart illustrating an exemplary method for identifying in dependence upon a text converted from a recorded message, by a library management system, content under management upon which to invoke a library management function.

FIG. 6 sets forth a flow chart illustrating an exemplary method for invoking, by a library management system, an identified library management function on an identified content.

### DETAILED DESCRIPTION OF EXEMPLARY EMBODIMENTS

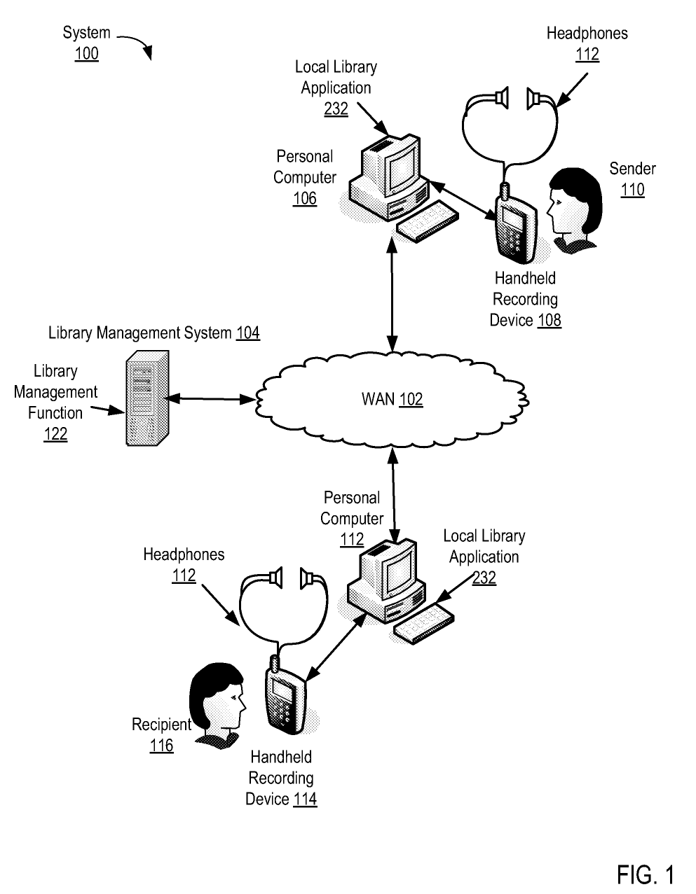

Exemplary methods, systems, and products for invoking content library management functions in accordance with the present invention are described with reference to the accompanying drawings, beginning with FIG. 1. FIG. 1 sets forth a network diagram of a system (100) for invoking content library management functions according to embodiments of the present invention. Content library management functions are software functions for administering content stored on a library management system in accordance with the present invention. Invoking content library management functions typically results in executing the software functions implementing the library management function such as deleting files under management of the library management system, moving files under management of the library management system, copying emails under management of the library management system, copying the files or content under management by the library management system and so on. Invoking content library management functions according to the present invention allows participants to perform desired content library management asynchronously and at their own convenience.

The system (100) of FIG. 1 includes two personal computers (106 and 112) coupled for data communications to a wide area network (‘WAN’) (102). Each of the personal computers (106 and 112) of FIG. 1 have installed upon them a local library application (232). The local library application (232) includes computer program instructions capable of transferring media files containing recorded messages to a handheld recording device (108 and 114). The local library application (232) also includes computer program instructions capable of communicating media files containing messages from and to the handheld recording device (108 and 114), and communicating the media files to and from a library management system (104).

The example of FIG. 1 also includes a library management system (104). The library management system of FIG. 1 is capable of asynchronous communications between senders and recipients by receiving a recorded message having been recorded on a handheld device (108) converting the recorded message to text; identifying a recipient (116) of the message in dependence upon the text; associating the message with content under management by a library management system in dependence upon the text; and storing the message for transmission to another handheld device (114) for the recipient. The exemplary library management system (104) of FIG. 1 manages asynchronous communications using recorded messages in accordance with the present invention, as well as additional content associated with those recorded messages. Such associated content under management include, for example, other recorded messages created by senders and recipients, emails, media files containing media content, spreadsheets, presentations, RSS (‘Really Simple Syndication’) feeds, web pages, and well as any other content that will occur to those of skill in the art. Maintaining the content as well as managing asynchronous communications relating to that content may provide tight coupling between the communications between users and the content related to those communications. Such tight coupling provides the ability to determine that content under management is the subject of the communications and therefore provide an identification of such content to a recipient. Such tight coupling also provides the ability to attach that content to the message providing together the content which is the subject of the communications and the communications themselves.

The example of FIG. 1, the library management system (104) is also capable of invoking content library management functions according to the present invention. The exemplary system (100) of FIG. 1 is capable of by recording a message from a sender (110) on the handheld recording device (108). The handheld recording device (108) includes a microphone for receiving speech of the message and is capable of recording the message in a media file. One handheld recording device useful according to embodiments of the present invention is the WP-U2J available from Samsung. The exemplary system (100) of FIG. 1 is capable of communicating the media file containing the recorded message from the handheld recording device (108) to the local library application (232) installed on a personal computer (106). Media files containing one or messages may be communicated to the local library application by periodically synchronizing the handheld recording device (108) with the local library application (232) allowing a sender to begin transmission of the message at the convenience of the sender (110).

The library management system (104) comprises computer program instructions capable of receiving the media file containing the recorded message provided by the sender (110); converting the recorded message to text; identifying a library management function (122) in dependence upon the text; identifying in dependence upon the text, content under management upon which to invoke the library management function (122); and invoking the identified library management function on the identified content. Content library management functions are software functions for administering content stored on a library management system in accordance with the present invention.

The exemplary system of FIG. 1 is also capable of transferring the media file containing the recorded message to a local library application (232) installed on a personal computer (112). The system of FIG. 1 is also capable of transmitting the message to the handheld recording device (114) of a recipient (116) who may listen to the message using headphones (112) or speakers on the device. A recipient may transfer messages to the handheld device by synchronizing the handheld recording device with the local library application (232) allowing the recipient to obtain messages at the recipients convenience. The recipient may now respond to the sender in the same manner providing two way asynchronous communications between sender and recipient. The recipient may also invoke content library management functions on the library management system in accordance with the present invention.

The arrangement of devices making up the exemplary system illustrated in FIG. 1 is for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), Bluetooth, proprietary protocols, and others as will occur to those of skill in the art. Various embodiments of the present invention may be implemented on a variety of hardware platforms in addition to those illustrated in FIG. 1.

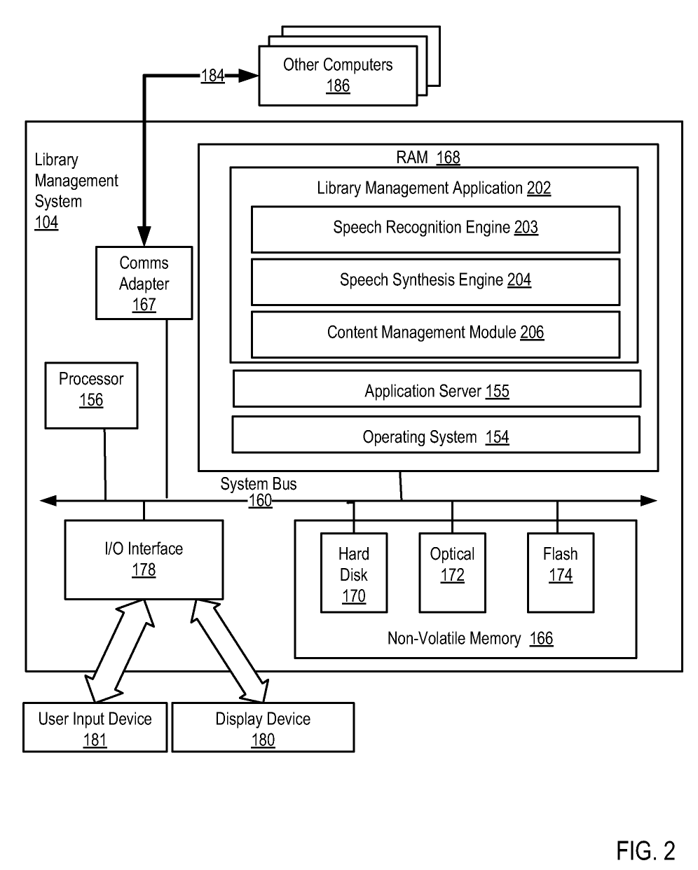

Invoking content library management functions in accordance with the present invention is generally implemented with computers, that is, with automated computing machinery. In the system (100) of FIG. 1, for example, all the nodes, servers, and communications devices are implemented to some extent at least as computers. For further explanation, therefore, FIG. 2 sets forth a block diagram of automated computing machinery comprising an exemplary library management system (104) useful in invoking content library management functions according to embodiments of the present invention. The library management system (104) of FIG. 2 includes at least one computer processor (156) or ‘CPU’ as well as random access memory (168) (‘RAM’) which is connected through a system bus (160) to processor (156) and to other components of the library management system.

Stored in RAM (168) is a library management application (202) for invoking content library management functions according to the present invention including computer program instructions for receiving a media file containing a message recorded on a handheld recording device; converting the recorded message to text; identifying a library management function in dependence upon the text; identifying in dependence upon the text, content under management upon which to invoke the library management function; and invoking the identified library management function on the identified content.

The library management application (202) of FIG. 2 includes a speech recognition engine (203) that contains computer program instructions for converting a recorded message to text. Examples of speech recognition engines capable of modification for use with library management applications according to the present invention include SpeechWorks available from Nuance Communications, Dragon NaturallySpeaking also available from Nuance Communications, ViaVoice available from IBM®, Speech Magic available from Philips Speech Recognition Systems, iListen from MacSpeech, Inc., and others as will occur to those of skill in the art.

The library management application (202) of FIG. 2 includes a speech synthesis engine (204), computer program instructions for creating speech identifying the content associated with the identified library management function. Examples of speech engines capable of creating speech identifying the content associated with the message, for example, IBM's ViaVoice Text-to-Speech, Acapela Multimedia TTS, AT&T Natural Voices™ Text-to-Speech Engine, and Python's pyTTS class.

The library management application (202) of FIG. 2 includes a content management module (206) containing computer program instructions for receiving a media file containing a message recorded on the handheld recording device; converting the recorded message to text using the speech recognition engine (203); identifying a library management function in dependence upon the text; identifying in dependence upon the text, content under management upon which to invoke the library management function; and invoking the identified library management function on the identified content. The content management module may also include computer program instructions for identifying a recipient of the message in dependence upon text that is converted from the message using the speech synthesis engine (204). The content management module (206) may also include computer program instructions for storing a media file with the identified content under management by the library management system (104) in dependence upon the text, and communicating the media file to the recipient (116).

Also stored in RAM (168) is an application server (155), a software platform that provides services and infrastructure required to develop and deploy business logic necessary to provide web clients with access to enterprise information systems. Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), application server (155), and library management application (202) in the example of FIG. 2 are shown in RAM (168), but many components of such software typically are stored in non-volatile memory (166) also.

Library management system (104) of FIG. 2 includes non-volatile computer memory (166) coupled through a system bus (160) to processor (156) and to other components of the library management system (104). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary library management system of FIG. 2 includes one or more input/output interface adapters (178). Input/output interface adapters in library management systems implement user-oriented input/output through, for example, software drivers and computer hardware for controlling output to display devices (180) such as computer display screens, as well as user input from user input devices (181) such as keyboards and mice.

The exemplary library management system (104) of FIG. 2 includes a communications adapter (167) for implementing data communications (184) with other computers (186). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for invoking content library management functions according to embodiments of the present invention include modems for wired dial-up communications, Ethernet (IEEE 802.3) adapters for wired network communications, and IEEE 802.11 a/b/g adapters for wireless network communications.

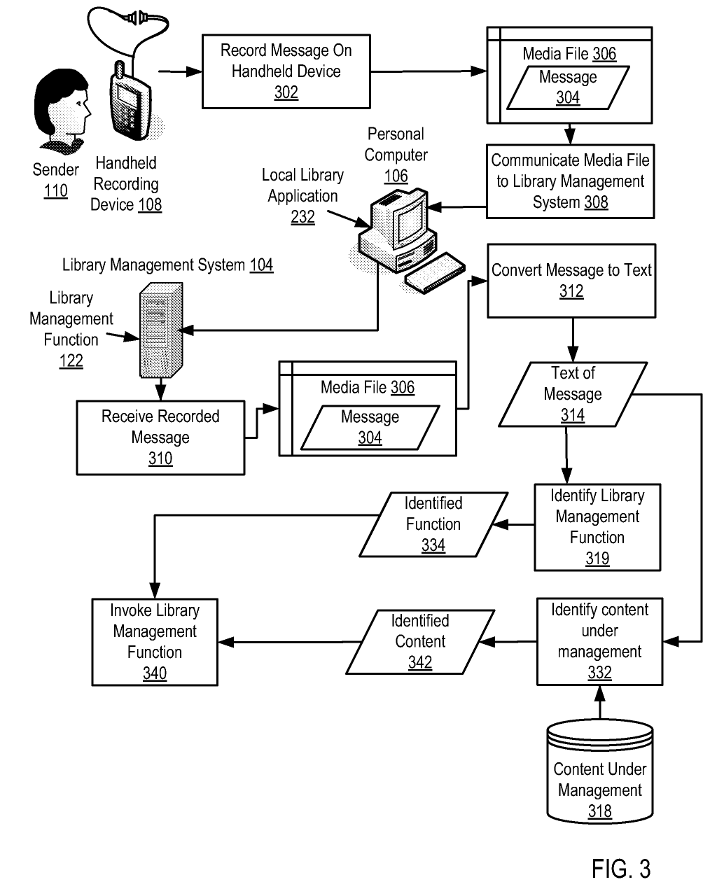

For further explanation, FIG. 3 sets forth a flow chart illustrating an exemplary method for invoking content library management functions according to embodiments of the present invention that includes recording (302) a message (304) on handheld device (108). In the example of FIG. 3 a sender (110) records a speech message on a handheld recording device (108) in a media file (306) of the data format supported by the handheld recording device (108). Examples of media files useful in invoking content library management functions according to the present invention include MPEG 3 (‘.mp3’) files, MPEG 4 (‘.mp4’) files, Advanced Audio Coding (‘AAC’) compressed files, Advances Streaming Format (‘ASF’) Files, WAV files, and many others as will occur to those of skill in the art.

The method of FIG. 3 includes communicating (308) a media file (306) containing the recorded message (304) to a library management system (104) through the personal computer 106. As discussed above, one way of communicating (308) a media file (306) containing the recorded message (304) to a library management system (104) includes synchronizing the handheld recording device (108) with a local library application (232) which in turns uploads the media file (306) to the library management system (104). Synchronizing the handheld recording device (108) with the local library application (232) may allow a sender (110) to record the message (304) at the sender's convenience and also enables the sender (110) to initiate the communication of the message (304) at the sender's convenience.

The method of FIG. 3 also receiving (310), by the library management system (104), the media file (306) containing the message (304). In the example of FIG. 3, a library management system (104) receives the message (304) in a media file (306) from a local library application (232). Local library applications (232) according to the present invention may be configured to upload messages from a sender (110) to a library management system (104) and download messages for delivery to a recipient (116) from a library management system (104) periodically, such as daily, hourly and so on, upon synchronization with handheld recording devices, or in any other manner as will occur to those of skill in the art.

The method of FIG. 3 also includes converting (312) the recorded message (304) to text (314). Converting (312) the recorded message (304) to text (314) may be carried out by a speech recognition engine (203) described with reference to FIG. 2. Speech recognition is the process of converting a speech signal to a set of words, by means of an algorithm implemented as a computer program. Different types of speech recognition engines currently exist. Isolated-word speech recognition systems, for example, require the speaker to pause briefly between words, whereas continuous speech recognition systems may not. Furthermore, some speech recognition systems may require a user to provide speech samples of the speaker before using the systems, whereas other systems are said to be speaker-independent and may not require a user to provide samples.

To accommodate larger vocabularies, speech recognition engines use language models or artificial grammars to restrict the combination of words and increase accuracy. The simplest language model can be specified as a finite-state network, where the permissible words following each word are explicitly given. More general language models approximating natural language are specified in terms of a context-sensitive grammar.

Examples of commercial speech recognition engines currently available include SpeechWorks available from Nuance Communications, Dragon NaturallySpeaking also available from Nuance Communications, ViaVoice available from IBM®, Speech Magic available from Philips Speech Recognition Systems, iListen from MacSpeech, Inc., and others as will occur to those of skill in the art.

The method of FIG. 3 also includes identifying (319) a library management function (122) in dependence upon the text (314). Identifying (319) a library management function (122) in dependence upon the text (314) may be carried out by scanning or parsing the text (314) for a match with the names or identifications of known identified library management functions. As mentioned above, content library management functions are software functions for administering content stored on a library management system in accordance with the present invention. Invoking content library management functions typically results in executing the software functions implementing the library management function such as deleting files under management of the library management system, moving files under management of the library management system, copying emails under management of the library management system, copying the files or content under management by the library management system and so on.

The method of FIG. 3 also includes identifying (332) in dependence upon the text (314), content (318) under management upon which to invoke the library management function (122). Identifying (332) in dependence upon the text (314) the content (122) under management upon which to invoke the library management function (122) may be carried out by scanning or parsing the text for a match with the name or other identification of known identified content under management. As described earlier, previously identified content under management may include, other recorded messages created by senders and recipients, e-mails, media files containing media content, spreadsheets, presentations, RSS (‘Really Simple Syndication’) feeds, web pages, and similar other content.

The method of FIG. 3 also includes invoking (340) the identified library management function (334) on the identified content (342). Invoking content library management functions typically includes executing the software functions implementing the library management function such as deleting files under management of the library management system, moving files under management of the library management system, copying emails under management of the library management system, copying the files or content under management by the library management system and so on.

Consider for further explanation, the following example of invoking content library management functions according to the present invention. In response to receiving a message containing speech converted to the text ‘send Jones presentation to manager’ from a sender (110), invoking content library management functions may include identifying a library management function of ‘sending an e-mail’ and identifying the content under management as the ‘Jones presentation’ Invoking content library management functions according to the present invention may include invoking the identified library management function on the identified content by sending the e-mail with the Jones presentation as an attachment.

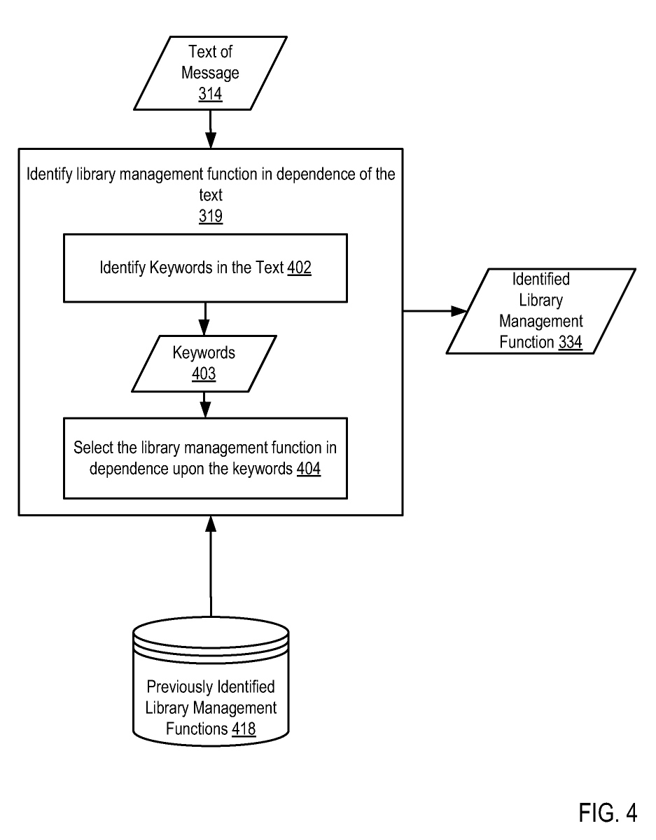

As discussed above, library management functions according to the present invention are identified in dependence upon text converted from speech recorded on handheld devices. For further explanation, therefore, FIG. 4 sets forth a flow chart illustrating an exemplary method for identifying (319) a library management function in dependence upon the text (314). Identifying (319) a library management function in dependence upon the text (314) includes identifying (402) keywords (403) in the text (314) and selecting (504) the library management function in dependence upon the keywords (503). Identifying (402) keywords (403) in the text (314) may be carried out by scanning words from the text that elicit information about a library management function such as, ‘deleting,’ ‘copying,’ ‘moving,’ and others as will occur to those of skill in the art. Identifying (402) keywords (403) in the text (314) may also be carried out by comparing words from the converted text with names of previously identified library management functions (418) stored as text in the library management system. Selecting (504) the library management function in dependence upon the keywords (503) may include selecting a library management function most closely resembling the one or more identified keyword.

In some cases, keywords may include an explicit identification of a library management function such as ‘forwarding associated message content by e-mail’ or ‘moving associated message content from a private disk storage area to a shared disk storage area’. Selecting (504) the library management function in dependence upon the keywords (503) may also include selecting a library management function most closely resembling the explicit identification of the library management function.

The examples of identifying keywords to identify library management function in dependence upon the text (314) are presented for explanation, and not for limitation. In fact, identifying the library management function in dependence upon the text (314) may be carried out in many ways as will occur to those of skill in the art and all such ways are within the scope of the present invention.

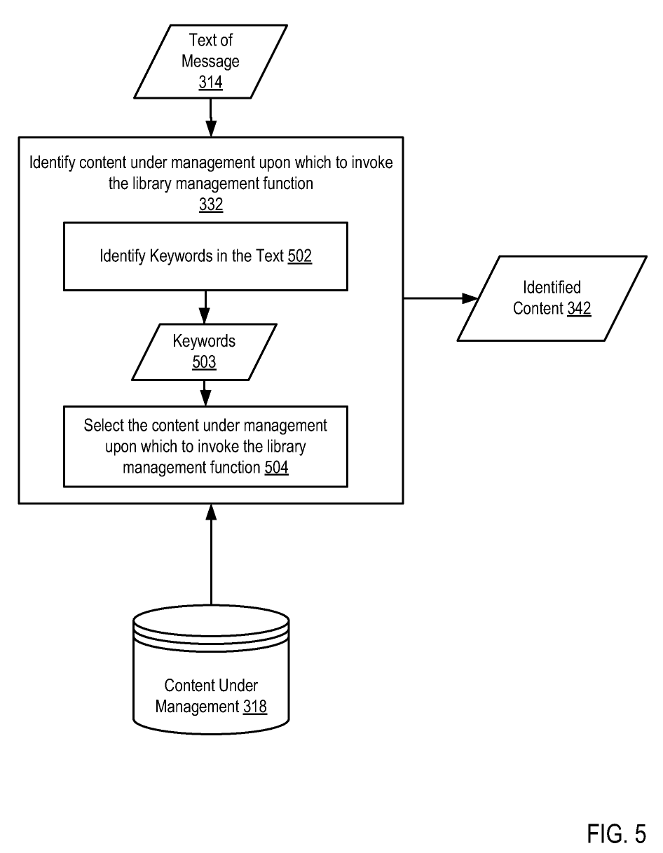

As discussed above, content upon which to invoke library management functions according to the present invention are identified in dependence upon text converted from speech recorded on handheld devices. For further explanation, therefore, FIG. 5 sets forth a flow chart illustrating an exemplary method for identifying (332) in dependence upon the text (314), content (318) under management upon which to invoke the library management function (122). Identifying (332) in dependence upon the text (314), content (318) under management upon which to invoke the library management function (122) includes identifying (502) keywords (503) in the text (314) and selecting (504) the content upon which to invoke the library management function in dependence upon the keywords (503). Identifying (502) keywords (503) in the text (314) may be carried out by scanning words from the text that are predetermined to elicit information about content under management such as a title, metadata identification, subject matter, content type and others as will occur to those of skill in the art.

Identifying (502) keywords (503) in the text (314) may also include matching keywords from the text that have temporal semantics, such as ‘yesterday,’ ‘Monday,’ ‘10:00 am’, and similar others. The examples of identifying words indicative of subject matter, content type, or temporal semantics are presented for explanation and not for limitation. In fact, identifying (502) in dependence upon the text (314), content (318) under management upon which to invoke the library management function (122) may be carried out in many ways as will occur to those of skill in the art and all such ways are within the scope of the present invention

Identifying (502) keywords (503) in the text (314) may also include identifying an explicit identification of the content under management (318). For example, ‘the Jones Presentation,’ may be an explicit identification of a PowerPoint™ Presentation entitled ‘Jones Presentation May 2, 2006.’ For example, the phrase ‘Your message of Yesterday,’ may be an explicit identification of a message from the intended recipient of the message sent a day earlier than the current message from which the text was converted according to the present invention. The examples of identifying keywords to identify content under management upon which to invoke the library management function (122) are presented for explanation and not for limitation. In fact, identifying the content under management (318) in dependence upon the text (314) and upon which to invoke the library management function (122) may be carried out in many ways as will occur to those of skill in the art and all such ways are within the scope of the present invention.

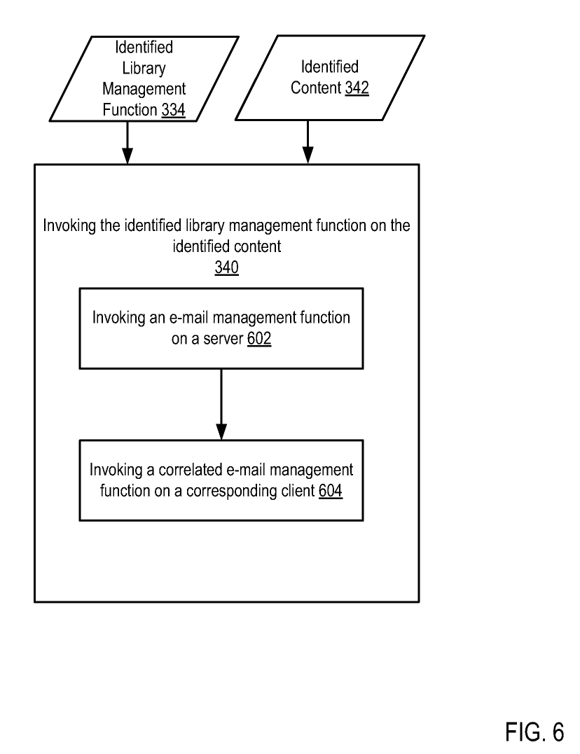

In some cases, the invocation of the identified library management function (334) on the identified content (342) may include invoking an e-mail function to enable further communications. For further explanation, FIG. 6 sets forth a flow chart illustrating a method for invoking (340) the identified library management function (334) on the identified content (342) by invoking (602) an e-mail management function on a server of the system (100) and invoking (604) a correlated e-mail management function in dependence upon the text on a corresponding client of the system (100) such as the personal computer (112) coupled to the handheld recording device (114) operable by the recipient (116).

The method of FIG. 6 which includes invoking an e-mail management function may include computer program instructions for composing, sending, storing, and receiving electronic messages over the ‘WAN’ (102) communications network described with reference to FIG. 1. The e-mail is implemented as a client/server system. A sender composes an e-mail message using a mail user agent (MUA) application such as Eudora, Lotus Notes, Microsoft Outlook, and similar others. The e-mail message is then sent by the Internet Service Provider (ISP) of the sender to a mail server on the Internet (or the Intranet) using the Simple Mail Transfer Protocol (SMTP), although e-mails exchanged via the Intranet may be based on a proprietary protocol. Recipients download their messages (or receive their e-mail) from the mail servers usually with either the Post Office Protocol (POP) or the Internet Message Access Protocol (IMAP). The example of invoking the e-mail management function as the identified library management function (334) is presented for explanation and not for limitation. In fact, other types of library management functions may be identified and invoked as will occur to those of skill in the art and all such ways are within the scope of the present invention.

Exemplary embodiments of the present invention are described largely in the context of a fully functional computer system for invoking content library management functions for messages recorded on handheld devices. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for invoking content library management functions, the method comprising:
receiving, by a library management system, a media file containing a message recorded on a handheld recording device;
converting, by the library management system, the recorded message to text;
identifying, by the library management system, a library management function in dependence upon the text;
identifying in dependence upon the text, by the library management system, content under management upon which to invoke the library management function; and
invoking, by the library management system, the identified library management function on the identified content.

2. The method of claim 1 further comprising:
recording the message on the handheld recording device; and
communicating the media file containing the message to the library management system.

3. The method of claim 2, wherein communicating the message to the library management system further comprises synchronizing the handheld recording device with a local library application.

4. The method of claim 1, wherein identifying the library management function in dependence upon the text further comprises:
identifying keywords in the text; and
selecting the library management function in dependence upon the keywords.

5. The method of claim 4 wherein identifying keywords in the text further comprises identifying an explicit identification of the library management function.

6. The method of claim 1, identifying in dependence upon the text, by the library management system, content under management upon which to invoke the library management function further comprises:
identifying keywords in the text; and
selecting the content upon which to invoke the library management function in dependence upon the keywords.

7. The method of claim 6 wherein identifying keywords in the text further comprises identifying an explicit identification of the content under management.

8. A system for invoking content library management functions, the system comprising a computer processor, a computer memory operatively coupled to the computer processor, the computer memory having disposed within it computer program instructions capable of:
receiving, by a library management system, a media file containing a message recorded on a handheld recording device;
converting, by the library management system, the recorded message to text;
identifying, by the library management system, a library management function in dependence upon the text;
identifying in dependence upon the text, by the library management system, content under management upon which to invoke the library management function; and
invoking, by the library management system, the identified library management function on the identified content.

9. The system of claim 7, wherein the computer memory also has disposed with in it computer program instructions capable of:
recording the message on the handheld recording device; and
communicating the media file containing the message to the library management system.

10. The system of claim 8, wherein communicating the message to the library management system further comprises synchronizing the handheld recording device with a local library application.

11. The system of claim 7, wherein computer program instructions capable of identifying the library management function in dependence upon the text further comprise computer program instructions capable of:
identifying keywords in the text; and
selecting the library management function in dependence upon the keywords.

12. The system of claim 7, wherein computer program instructions capable of identifying in dependence upon the text, by the library management system, content under management upon which to invoke the library management function further comprise computer program instructions capable of:
identifying keywords in the text; and
selecting the content upon which to invoke the library management function in dependence upon the keywords.

13. A computer program product for invoking content library management functions, the computer program product embodied on a computer-readable medium, the computer program product comprising:
computer program instructions for receiving, by a library management system, a media file containing a message recorded on a handheld recording device;
computer program instructions for converting, by the library management system, the recorded message to text;
computer program instructions for identifying, by the library management system, a library management function in dependence upon the text;
computer program instructions for identifying in dependence upon the text, by the library management system, content under management upon which to invoke the library management function; and
computer program instructions for invoking, by the library management system, the identified library management function on the identified content.

14. The computer program product of claim 13 further comprising computer program instructions for recording the message on the handheld recording device; and computer program instructions for communicating the media file containing the message to the library management system.

15. The computer program product of claim 14, wherein computer program instructions for communicating the message to the library management system further comprises computer program instructions for synchronizing the handheld recording device with a local library application.

16. The computer program product of claim 13, wherein computer program instructions for identifying the library management function in dependence upon the text further comprise:
computer program instructions for identifying keywords in the text; and
computer program instructions for selecting the library management function in dependence upon the keywords.

17. The computer program product of claim 13, wherein computer program instructions for identifying in dependence upon the text, by the library management system, content under management upon which to invoke the library management function further comprise:
computer program instructions for identifying keywords in the text; and
computer program instructions for selecting the content upon which to invoke the library management function in dependence upon the keywords.

18. The computer program product of claim 13, wherein the computer readable medium comprises a recordable medium.

19. The computer program product of claim 13, wherein the computer readable medium comprises a transmission medium.
